(19) United States
(12) Patent Application Publication
(10) Pub. No.: US 2016/0343005 A1
(43) Pub. Date: Nov. 24, 2016

(54) VISUALLY DISPLAYING RELATIONSHIPS AMONG COMPANIES

(71) Applicant: Linkedln Corporation, Mountain View, CA (US)

(72) Inventors: Ying Liu, Palo Alto, CA (US); Haipeng Li, Mountain View, CA (US)

(21) Appl. No.: 14/720,104

(22) Filed: May 22, 2015

(51) Int. Cl. G06Q 30/02

(52) U.S. Cl. CPC G06Q 30/0201

(57) ABSTRACT

A social network may visually display relationships among companies, optionally using talent flow among the companies to define proximity of the companies to one another. Talent flow between first and second companies may be defined as a number of employees switching employment between the first and second companies within a specified time window, normalized by first and second company size. The social network may track the changes in employment for the employees of the first and second companies. In a visual representation, companies with relatively high talent flow may be grouped closer together than companies with relatively low talent flow. In some examples, the visual representation may be a force-directed graph drawing in which an edge connecting first and second nodes has a length that varies inversely with strength of the talent flow between first and second companies corresponding to the first and second nodes.

### BACKGROUND

A social network system is a computer or web-based service that enables users to establish links or connections with persons for the purpose of sharing information with one another. Some social network systems aim to enable friends and family to communicate and share with one another, while others are specifically directed to business users with a goal of establishing professional networks and sharing business information. For purposes of the present disclosure, the terms “social network” and “social network system” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows a diagram of a social network service, in accordance with some examples.

FIG. 2 shows an example of a visual representation showing a plurality of companies as nodes and showing relationships among the plurality of companies as edges connecting the nodes, in accordance with some examples.

FIG. 3 shows an example of a method for visually displaying relationships among companies, the companies having employees that are members of a social network, in accordance with some examples.

FIG. 4 illustrates a block diagram of an example of a machine upon which any one or more of the techniques (e.g., methodologies) discussed herein may perform.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business network system. The present inventive subject matter is generally applicable to a wide range of information services.

A social network system is a service provided by one or more computer systems accessible over a network that allows members of the service to build or reflect social networks or social relations among members. Typically, members construct profiles, which may include personal information such as the member's name, contact information, employment information, photographs, personal messages, status information, multimedia, links to web-related content, blogs, and so on. In order to build or reflect these social networks or social relations among members, the social network system allows members to identify and establish links or connections with other members. For instance, in the context of a business network system (a type of social network system), a person may establish a link or connection with his or her business contacts, including work colleagues, clients, customers, personal contacts, and so on. With a social network system, a person may establish links or connections with his or her friends, family, or business contacts. While a social network system and a business network system may be generally described in terms of typical use cases (e.g., for personal and business networking, respectively), it will be understood by one of ordinary skill in the art that a business network system may be used for personal purposes (e.g., connecting with friends, classmates, former classmates, and the like) as well as or instead of business networking purposes and a social network system may likewise be used for business networking purposes as well as or in place of social networking purposes. A connection may be formed using an invitation process in which one member invites a second member to form a link. The second member then has the option of accepting or declining the invitation.

In general, a connection or link represents or is otherwise associated with an information access privilege, such that a first person who has established a connection with a second person is, via the establishment of that connection, authorizing the second person to view or access certain non-publicly available portions of their profiles that may include communications they have authored. Example communications may include blog posts, messages, wall postings, or the like. Depending on the particular implementation of the business/social network system, the nature and type of the information that may be shared, as well as the granularity with which the access privileges may be defined to protect certain types of data, may vary greatly.

Some social network systems may offer a subscription or following process to create a connection instead of or in addition to the invitation process. A subscription or following model is where one member follows another member without the need for mutual agreement. Typically in this model, the follower is notified of public messages and other communications posted by the member that is followed. An example social network system that follows this model is Twitter®, which is a micro-blogging service that allows members to follow other members without explicit permissions. Other, connection based social network systems also may allow following type relationships as well. For example, the social network system LinkedIn® allows members to follow particular companies.

A social network may visually display relationships among companies, where companies that are more closely related may be grouped closer together than companies that are less closely related. Such a visual representation may be useful for targeting companies from which to recruit new employees. Such a visual representation may also be useful for businesses that involve sales or sales contacts.

In some examples, the social network may use talent flow to define the grouping of the companies in the visual representation. For instance, if an employee has left a first company to join a second company, the social network may draw a link between the first and second companies in the visual representation. If a relatively large number of employees have moved between the first and second companies, the talent flow between the first and second companies may be relatively strong, and the social network may position the first and second companies relatively close together in the visual representation, so that the link between the first and second companies may be relatively short. If relatively few employees have moved between the first and second companies, the talent flow between the first and second companies may be relatively weak, and the social network may position the first and second companies relatively far apart in the visual representation, so that the link between the first and second companies may be relatively long.

In some examples, talent flow between first and second companies may include a number of employees switching employment between the first and second companies within a specified time window, normalized by first and second company size. In some of these examples, the social network may track the talent flow automatically, based on the reporting of employment changes from members of the social network. For these examples, talent flow between first and second companies may include employees that have reported to the social network leaving one of the first or second companies and joining the other of the first or second companies within a specified time window. In some examples, the specified time window may be a most recent three months, a most recent quarter, or a current quarter; other suitable time windows may also be used.

In some examples, the visual representation may be a force-directed graph drawing in which an edge connecting first and second nodes has a length that varies inversely with strength of the talent flow between first and second companies corresponding to the first and second nodes.

Disclosed in some examples are systems, methods, and machine readable media for visually displaying relationships among companies, where the companies may have employees that are members of a social network. In some examples, a user may select a company on a user interface of the social network. The social network may retrieve talent movement data relating a plurality of companies to one another, where the plurality of companies may include the selected company. The social network may form, from the retrieved talent movement data, a visual representation showing the plurality of companies as nodes and showing relationships among the plurality of companies as edges connecting the nodes. The social network may display the visual representation on the user interface.

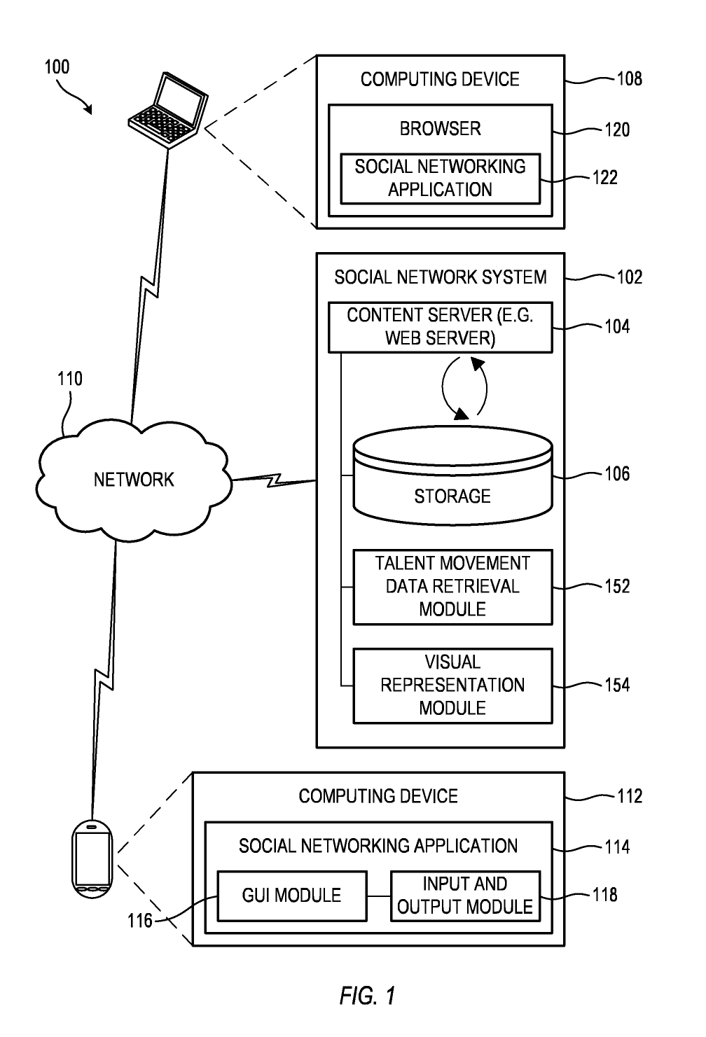

FIG. 1 shows a diagram of a social network service 100, in accordance with some examples. Social network system 102 may contain a content server 104. Content server 104 may communicate with storage 106 and may communicate with one or more computing devices 108 and 112 through a network 110. Content server 104 may be responsible for the retrieval, presentation, and maintenance of member profiles stored in storage 106 as well as the retrieval, creation, and presentation of a user interface for users. Content server 104 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 108. The content server 104 may also be responsible for allowing members to communicate with one another, establish connections, and post multi-media files (e.g., pictures, videos, and the like).

Users of computing devices 108 and 112 may include one or more members, prospective members, or other users of the social network system 102. Computing devices 108 and 112 communicate with social network system 102 through a network 110. The network may be any means of enabling the social network system 102 to communicate data with computing devices 108, 112. Example networks 110 may be or include portions of one or more of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Computing device 108 may be a laptop, desktop, tablet, cellphone or any other computing device which may provide a social networking application 122 in conjunction with browser 120. Social networking application 122 may be one or more of hypertext markup language (HTML), JavaScript, Java, or other browser executable objects that are executed within the browser 120 to provide social networking functionality to a user. The social networking application 122 may be deployed to the computing device 108 by content server 104 through interaction with browser 120.

Computing device 112 may be a laptop, desktop, tablet, cellphone, or any other computing device which may provide a social networking functionality to the user through execution of a social networking application 114. Social networking application 114 may include a graphical user interface (GUI) module 116 which may provide a graphical user interface output to a display which may show social networking information. Input and output module 118 may accept input and process it in order to update the graphical user interface provided by the GUI module 116. Input and output module 118 may interface with the social network system 102 through the content server 104 using one or more application programming interfaces (APIs). For example input and output module may receive data related to the social network system (e.g., member profile information, GUI information, and other data) by interfacing through one or more application programming interfaces (APIs).

Both social networking applications 122 and 114 may provide social networking functionality to users in conjunction with content server 104, and in some examples in conjunction with storage 106. Social networking functionality may include viewing, editing, or deleting information in member profiles, communicating with other members, adding or removing skills, and the like.

The social network system may include various modules, connected to the content server 104 and storage 106, which may prompt a user or member and receive input from the user or member. In response to a selection of a selected company on a user interface provided to a user, the modules may retrieve, from the social network, talent movement data relating a plurality of companies to one another, the plurality of companies including the selected company, create a visual representation, from the retrieved talent movement data, showing the plurality of companies as nodes and showing relationships among the plurality of companies as edges connecting the nodes and provide the visual representation to the user.

A talent movement data retrieval module 152 may retrieve, from the content server 104, talent movement data relating a plurality of companies to one another, where the plurality of companies includes the selected company. In some examples, the talent movement data can include talent flow between companies. In some examples, talent flow can represent employees leaving one company and joining another company. In some examples, talent flow may include employees that have reported to the social network leaving one of the plurality of companies and joining another of the plurality of companies within a specified time window. These are but a few examples; other suitable data may also be retrieved.

A visual representation module 154 may receive data retrieved from the talent movement data retrieval module 152, and may create a visual representation of the retrieved data on a user interface. In some examples, the visual representation may be a force-directed graph drawing in which an edge connecting first and second nodes has a length that varies inversely with strength of the talent flow between first and second companies corresponding to the first and second nodes. This is but one example; other suitable visual representations may also be used.

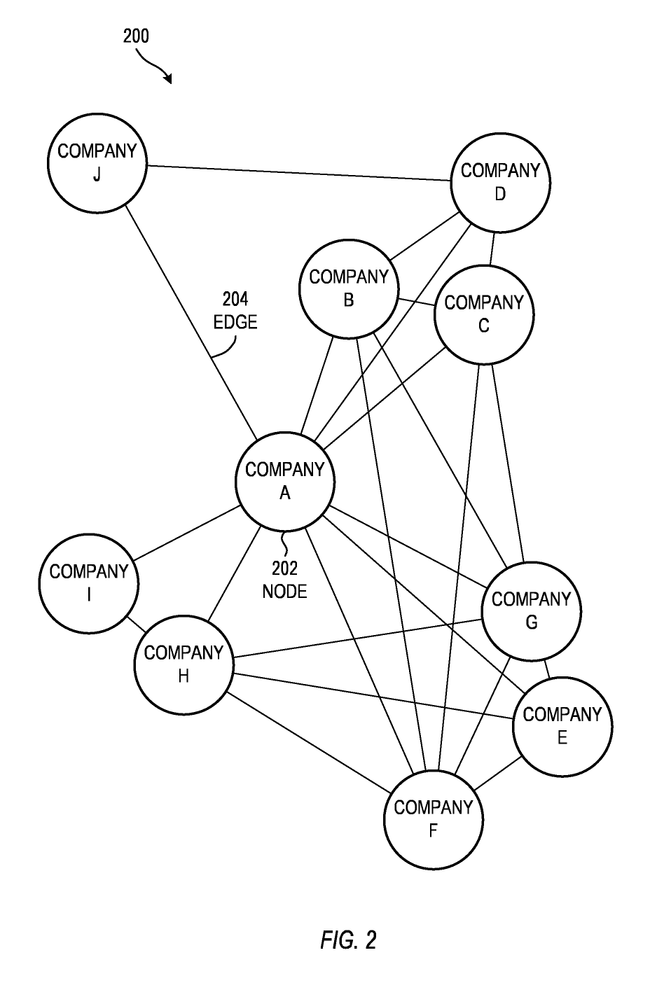

FIG. 2 shows an example of a visual representation 200, which shows a plurality of companies as nodes 202 and showing relationships among the plurality of companies as edges 204 connecting the nodes 202, in accordance with some examples. During use, in response to a user's selection of a selected company on a user interface, the social network may display all or part of the visual representation 200 on all or a portion of the user interface.

In the example of FIG. 2, the user has selected Company A. The visual representation 200 shows Companies B through J as being connected to Company A. As a result, the node 202 corresponding to Company A is connected by edges 204 to nodes 202 corresponding to each of Companies B-J.

In some examples, the relationships (shown as edges 204) among the companies (shown as nodes 202) between selected Company A and respective other Companies B through J may represent talent flow among the companies. In some examples, talent flow can represent employees leaving one company and joining another company. In some examples, talent flow may include employees that have reported to the social network leaving one of the plurality of companies and joining another of the plurality of companies within a specified time window. In the example of FIG. 2, talent has flowed between Company A (e.g., the selected company) and each of Companies B-J, but not all of Companies B-J have exchanged talent among each other, within the specified time window. For instance, in the example of FIG. 2, talent has flowed between Companies I and H, but not between Companies I and J, within the specified time window. As a result, an edge 204 connects nodes 202 corresponding to Companies I and H, but nodes 202 corresponding to Companies I and J are not connected by a node 202.

In some examples, such as in FIG. 2, the visual representation 200 may be a force-directed graph drawing in which an edge 204 connecting first and second nodes 202 has a length that varies inversely with a strength of the talent flow between first and second companies corresponding to the first and second nodes 202.

In order to form the visual representation 200, the social network may retrieve talent movement data relating a plurality of companies to one another, where the plurality of companies includes the selected company. In some examples, the social network may perform calculations from the retrieved talent movement data, in order to determine where to position the nodes 202. In some examples, the talent movement data can include member data from members of the social network who are/were employees of particular companies, data from a talent solutions platform, or other suitable data.

In some examples, the social network may calculate a strength of the talent flow among the plurality of companies, to determine positions of the companies as nodes 202 in the visual representation 200. In one specific example, the social network may calculate a strength of the talent between the first and second companies, as follows. In this specific example, the social network may retrieve quantities A, B, C, and D, as part of the retrieved talent movement data. Quantity A may represent a number of employees that reported to the social network that they left the first company and joined the second company within a specified time window. Quantity B may represent a number of employees that reported to the social network that they left the second company and joined the first company within the specified time window. Quantity C may represent a number of employees employed by the first company. Quantity D may represent a number of employees employed by the second company. In this specific example, the social network may calculate the quantity (A+B)/(C+D), where the strength of the talent flow between the first and second companies may vary with the calculated quantity. For instance, the strength may be proportional to the calculated quantity. The social network may calculate the quantity (A+B)/(C+D) for each pair of connected companies in FIG. 2, and may apply a force-directed graph layout algorithm to determine the node locations in FIG. 2 based on the calculated quantities. Suitable force-directed graph layout algorithms can include techniques in which attractive, repulsive, and/or spring/like forces are assigned to the nodes, and the edge lengths are varied to minimize an energy of the node distribution.

In this specific example, the calculated quantity includes (C+D) in its denominator, which normalizes the calculated quantity to the respective company sizes. Such normalization to company size may reduce or eliminate bias of talent flow toward larger companies, with respect to positioning in the visual representation 200, which may be beneficial.

In some examples, the number of employees employed by the first company may include a number of members of the social network that indicate on the social network that they are employed by the first company at the end of the specified time window. Similarly, in some examples, the number of employees employed by the second company may include a number of members of the social network that indicate on the social network that they are employed by the second company at the end of the specified time window. In other examples, the social network may use additional data to determine the size of the first and/or second company. The additional data may include one or more values obtained from sources such as company websites, company annual reports, and other company literature, and entered into the social network.

In another specific example, the social network may use connections between company employees to determine positions of the companies as nodes 202 in the visual representation 200, as follows. In this specific example, the social network may retrieve quantities E, F, and G, as part of the retrieved talent movement data. Quantity E may represent a number of pairs of employees connected on the social network, where a first of each pair of employees is employed by the first company and a second of each pair of employees is employed by the second company. Quantity F may represent a number of employees employed by the first company. Quantity G may represent a number of employees employed by the second company. In this specific example, the social network may calculate the quantity (E)/(F+G), where the strength of the talent flow (or potential talent flow) between the first and second companies may vary with the calculated quantity. These are but two specific examples; other suitable calculated quantities may also be used.

In some examples, the plurality of companies shown in a visual representation, such as 200, may include all the companies having current employees that have left the selected company to join one of said companies within a specified time window, plus all the companies having former employees that have left one of said companies to join the selected company within the specified time window. In other examples, the companies shown in the visual representation may be thresholded to include only the companies closest to the selected company. In still other examples, the companies shown in the visual representation may be thresholded to include no more than a specified number of companies, where the companies shown are those closest to the selected company.

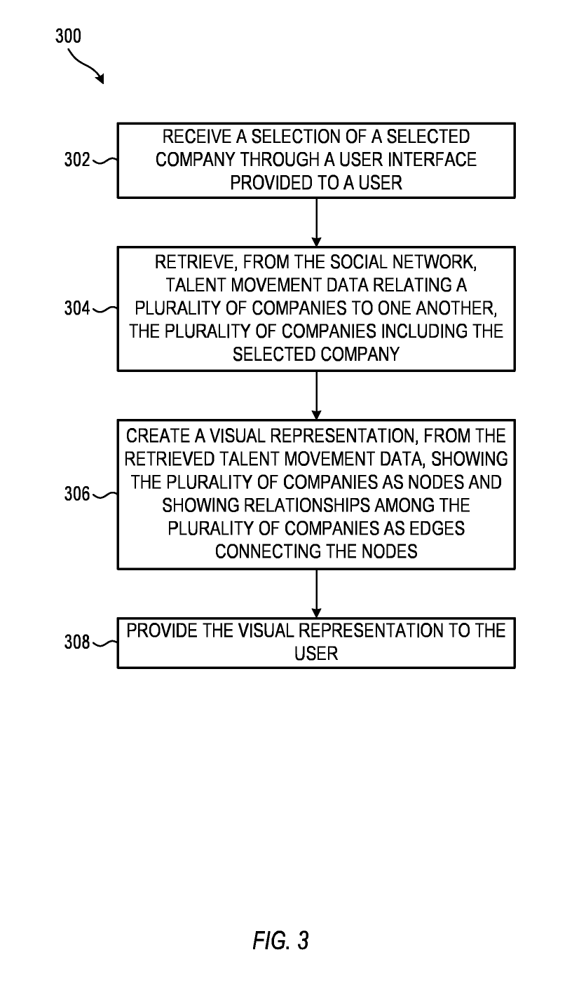

FIG. 3 shows an example of a method 300 for visually displaying relationships among companies, where the companies may have employees that are members of a social network. The method 300 may be executed on at least one computer processor in the social networking service 100 of FIG. 1, or on other suitable computer processors or other suitable social networking services. The method 300 is but one example, and other suitable methods for visually displaying relationships among companies may also be used.

At operation 302, the at least one computer processor may receive a selection of a selected company through a user interface provided to a user.

At operation 304, the at least one computer processor may retrieve, from the social network, talent movement data relating a plurality of companies to one another. The plurality of companies may include the selected company.

At operation 306, the at least one computer processor may create a visual representation, from the retrieved talent movement data, showing the plurality of companies as nodes and showing relationships among the plurality of companies as edges connecting the nodes. In some examples, the relationships among the companies include talent flow among the plurality of companies. In some of these examples, the talent flow includes employees that have reported to the social network leaving one of the plurality of companies and joining another of the plurality of companies within a specified time window. In some examples, the specified time window includes a most recent quarter, although other suitable time windows may also be used.

At operation 308, the at least one computer processor may provide the visual representation to the user.

In some examples, the social network may repeat method 300 for different time windows, to produce different visual representations for the corresponding time windows. For instance, the social network may produce visual representations that evolve over time, as the time window is shifted in time. For these examples, the at least one computer processor may display the different visual representations on the user interface. For instance, the user interface may display one visual representation at a time, such as sequentially. In some examples, the social network may employ animation to evolve one visual representation into a subsequent or previous visual representation. In other examples, the user interface may display more than one visual representation at a time, such as showing a plurality of sequentially adjacent visual representations.

In some alternative configurations, the social network can display visual representations of other organizations, in addition to companies. For example, the social network can display visual representations of high schools, universities, or other academic institutions.

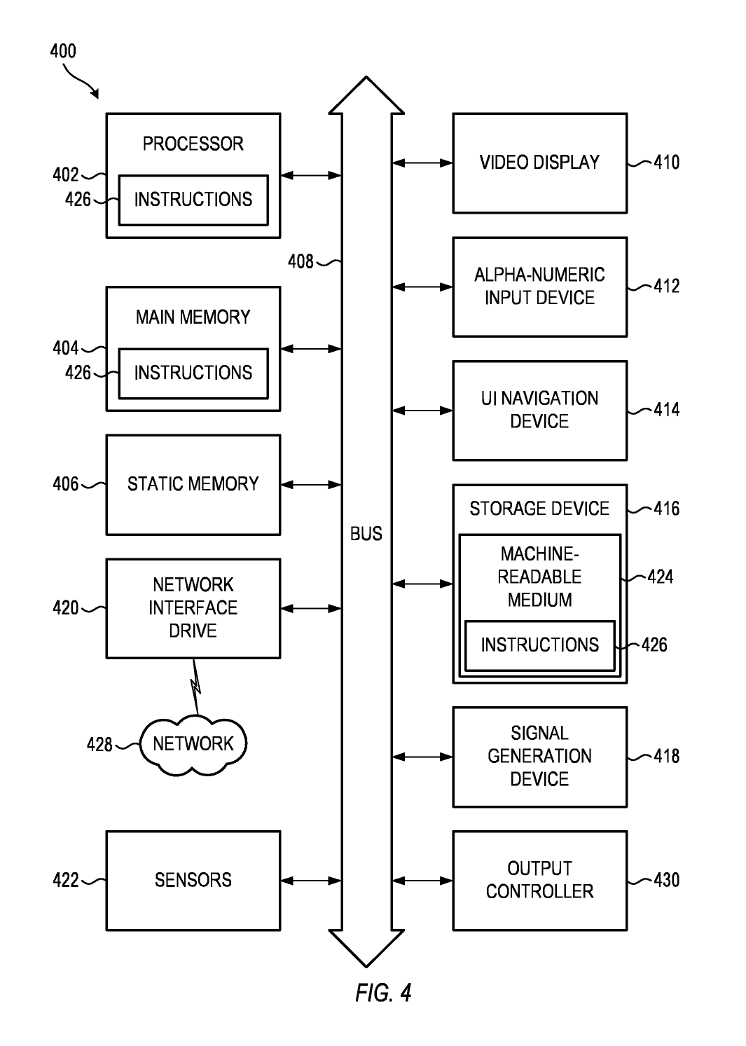

FIG. 4 illustrates a block diagram of an example of a machine 400 upon which any one or more of the techniques (e.g., methodologies) discussed herein may perform. The components of FIG. 1 may execute upon and/or include one or more of the components in FIG. 4. In alternative examples, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a server, personal computer (PC), a tablet PC, a set-top box (STB), a personal digital assistant (PDA), a mobile telephone, a smart phone, a web appliance, a network router, switch or bridge, a component of a social networking service, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules include a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 422, such as a global positioning system (GPS) sensor, compass, accelerometer, or other sensor. The machine 400 may include an output controller 430, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 424 on which is stored one or more sets of data structures or instructions 426 (e.g., software) embodying or utilized by any one or more of the techniques or functions described herein. The instructions 426 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 424 is illustrated as a single medium, the term “machine readable medium” may include a single medium or multiple media (e.g., a centralized or distributed database, and/or associated caches and servers) configured to store the one or more instructions 426.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 426 may further be transmitted or received over a communications network 428 using a transmission medium via the network interface device 420. The machine 400 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 428. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

What is claimed is:

1. A method for visually displaying relationships among companies, the companies having employees that are members of a social network, the method comprising:
using at least one computer processor to:
receive a selection of a selected company on a user interface provided to a user;
retrieve, from the social network, talent movement data relating a plurality of companies to one another, the plurality of companies including the selected company;
create a visual representation, from the retrieved talent movement data, showing the plurality of companies as nodes and showing relationships among the plurality of companies as edges connecting the nodes; and
provide the visual representation to the user.

2. The method of claim 1, wherein the relationships among the companies comprise talent flow among the plurality of companies.

3. The method of claim 2, wherein the talent flow comprises employees that have reported to the social network leaving one of the plurality of companies and joining another of the plurality of companies within a specified time window.

4. The method of claim 3, wherein the specified time window comprises a most recent quarter.

5. The method of claim 2, wherein the visual representation is a force-directed graph drawing in which an edge connecting first and second nodes has a length that varies inversely with a strength of the talent flow between first and second companies corresponding to the first and second nodes.

6. The method of claim 5,
wherein the retrieved talent movement data includes quantity A, quantity A representing a number of employees that reported to the social network that they left the first company and joined the second company within a specified time window;
wherein the retrieved talent movement data includes quantity B, quantity B representing a number of employees that reported to the social network that they left the second company and joined the first company within the specified time window;
wherein the retrieved talent movement data includes quantity C, quantity C representing a number of employees employed by the first company;
wherein the retrieved talent movement data includes quantity D, quantity D representing a number of employees employed by the second company; and
wherein the strength of the talent flow between the first and second companies varies with the quantity (A+B)/(C+D).

7. The method of claim 6,
wherein the number of employees employed by the first company comprises a number of members of the social network that indicate on the social network that they are employed by the first company at the end of the specified time window; and
wherein the number of employees employed by the second company comprises a number of members of the social network that indicate on the social network that they are employed by the second company at the end of the specified time window.

8. The method of claim 5,
wherein the retrieved talent movement data includes quantity E, quantity E representing a number of pairs of employees connected on the social network, wherein a first of each pair of employees is employed by the first company and a second of each pair of employees is employed by the second company;
wherein the retrieved talent movement data includes quantity F, quantity F representing a number of employees employed by the first company;
wherein the retrieved talent movement data includes quantity G, quantity G representing a number of employees employed by the second company; and
wherein the strength of the talent flow between the first and second companies varies with the quantity (E)/(F+G).

9. The method of claim 8,
wherein the number of employees employed by the first company comprises a number of members of the social network that indicate on the social network that they are employed by the first company at the end of the specified time window; and
wherein the number of employees employed by the second company comprises a number of members of the social network that indicate on the social network that they are employed by the second company at the end of the specified time window.

10. The method of claim 1, wherein the plurality of companies comprises all the companies having current employees that have left the selected company to join one of said companies within a specified time window, plus all the companies having former employees that have left one of said companies to join the selected company within the specified time window.

11. A social network system for visually displaying relationships among companies, the companies having employees that are members of a social network, the system comprising:
at least one processor; and
memory, including instructions that, when executed on the at least one processor, cause the at least one processor to:
receive a selection of a selected company on a user interface provided to a user;
retrieve, from the social network, talent movement data relating a plurality of companies to one another, the plurality of companies including the selected company;
create a visual representation, from the retrieved talent movement data, showing the plurality of companies as nodes and showing relationships among the plurality of companies as edges connecting the nodes; and
provide the visual representation to the user.

12. The system of claim 11,
wherein the relationships among the companies comprise talent flow among the plurality of companies; and
wherein the talent flow comprises employees that have reported to the social network leaving one of the plurality of companies and joining another of the plurality of companies within a specified time window.

13. The system of claim 12, wherein the visual representation is a force-directed graph drawing in which an edge connecting first and second nodes has a length that varies inversely with a strength of the talent flow between first and second companies corresponding to the first and second nodes.

14. The system of claim 13,
wherein the retrieved talent movement data includes quantity A, A representing a number of employees that reported to the social network that they left the first company and joined the second company within a specified time window;
wherein the retrieved talent movement data includes quantity B, B representing a number of employees that reported to the social network that they left the second company and joined the first company within the specified time window;
wherein the retrieved talent movement data includes quantity C, C representing a number of employees employed by the first company;
wherein the retrieved talent movement data includes quantity D, D representing a number of employees employed by the second company; and
wherein the strength of the talent flow between the first and second companies varies with the quantity (A+B)/(C+D).

15. The system of claim 14,
wherein the number of employees employed by the first company comprises a number of members of the social network that indicate on the social network that they are employed by the first company at the end of the specified time window; and
wherein the number of employees employed by the second company comprises a number of members of the social network that indicate on the social network that they are employed by the second company at the end of the specified time window.

16. The system of claim 13,
wherein the retrieved talent movement data includes quantity E, E representing a number of pairs of employees connected on the social network, wherein a first of each pair of employees is employed by the first company and a second of each pair of employees is employed by the second company;
wherein the retrieved talent movement data includes quantity F, F representing a number of employees employed by the first company;
wherein the retrieved talent movement data includes quantity G, G representing a number of employees employed by the second company; and
wherein the strength of the talent flow between the first and second companies varies with the quantity (E)/(F+G).

17. The system of claim 16,
wherein the number of employees employed by the first company comprises a number of members of the social network that indicate on the social network that they are employed by the first company at the end of the specified time window; and
wherein the number of employees employed by the second company comprises a number of members of the social network that indicate on the social network that they are employed by the second company at the end of the specified time window.

18. The system of claim 11, wherein the plurality of companies comprises all the companies having current employees that have left the selected company to join one of said companies within a specified time window, plus all the companies having former employees that have left one of said companies to join the selected company within the specified time window.

19. A non-transitory machine-readable medium, including instructions, which when executed by the machine, cause the machine to perform operations for visually displaying relationships among companies, the companies having employees that are members of a social network, the operations comprising:
receiving a selection of a selected company on a user interface provided to a user;
retrieving, from the social network, talent movement data relating a plurality of companies to one another, the plurality of companies including the selected company;
creating a visual representation, from the retrieved talent movement data, showing the plurality of companies as nodes and showing relationships among the plurality of companies as edges connecting the nodes; and
providing the visual representation to the user.

20. The machine-readable medium of claim 19,
wherein the relationships among the companies comprise talent flow among the plurality of companies;
wherein the talent flow comprises employees that have reported to the social network leaving one of the plurality of companies and joining another of the plurality of companies within a specified time window;
wherein the visual representation is a force-directed graph drawing in which an edge connecting first and second nodes has a length that varies inversely with a strength of the talent flow between first and second companies corresponding to the first and second nodes;
wherein the retrieved talent movement data includes quantity A, A representing a number of employees that reported to the social network that they left the first company and joined the second company within a specified time window;
wherein the retrieved talent movement data includes quantity B, B representing a number of employees that reported to the social network that they left the second company and joined the first company within the specified time window;
wherein the retrieved talent movement data includes quantity C, C representing a number of employees employed by the first company;
wherein the retrieved talent movement data includes quantity D, D representing a number of employees employed by the second company; and
wherein the strength of the talent flow between the first and second companies varies with the quantity (A+B)/(C+D).
